(19) United States
(12) Patent Application Publication
(10) Pub. No.: US 2022/0271556 A1
(43) Pub. Date: Aug. 25, 2022

(54) CURRENT CONTROL FOR MULTI-PORT CHARGING CIRCUIT

(71) Applicant: TEXAS INSTRUMENTS INCORPORATED, Dallas, TX (US)

(72) Inventors: Peng TANG, Shanghai (CN); Gregory Wallis COLLINS, Richardson, TX (US)

(21) Appl. No.: 17/513,955

(22) Filed: Oct. 29, 2021

Related U.S. Application Data
(60) Provisional application No. 63/153,432, filed on Feb. 25, 2021.

(51) Int. Cl. H02J 7/00

(52) U.S. Cl. CPC H02J 7/00718; H02J 7/00304; H02J 7/0063

(57) ABSTRACT

In a described example, a circuit includes a port power path circuit having a power input and a first overload output. An interlock logic circuit has an interlock input, a current limit input and a current limit set output. The current limit input is coupled to the first overload output, and the interlock input is adapted to be coupled to a second overload output of a second port power circuit. The interlock logic circuit is configured to delay providing an output signal to the current limit set output responsive to an overload signal at the current limit input.

### CROSS REFERENCE TO RELATED APPLICATION

This application claims priority to U.S. Provisional Patent Application 63/153,432 filed on Feb. 25, 2021, the entirety of which is incorporated by reference herein.

### TECHNICAL FIELD

This description relates to controlling current for multi-port charging circuitry, such as for universal serial bus (USB) charging systems.

### BACKGROUND

Electrical charging systems, such as for universal serial buses (USBs), can include multiple output ports. One or more loads (e.g., electrical devices) can be coupled individually to a respective output port for charging. The electrical charging system can be configured to sense current provided to its output ports and implement protective actions responsive to the sensed current and other monitored load conditions. The manner in which the electrical charging system implements the protection can vary according to system protection requirements, such as can be established by industry standards as well as user requirements. Various tests can be designed to ensure that the electrical charging system meets or exceeds the established standards.

### SUMMARY

In a described example, a circuit includes a port power path circuit having a power input and a first overload output. An interlock logic circuit has an interlock input, a current limit input and a current limit set output. The current limit input is coupled to the first overload output, and the interlock input is adapted to be coupled to a second overload output of a second port power circuit. The interlock logic circuit is configured to delay providing an output signal to the current limit set output responsive to an overload signal at the current limit input.

In another described example, a circuit includes a first port power circuit and a second power port circuit. The first power port circuit includes a first port power path circuit configured to control a first current supplied to a first port output. The first port power path circuit is further configured to provide a first overload signal to a first overload output and remain in an overload state for a first time interval responsive to detecting the first current exceeds a respective current limit setting. The second port power circuit includes a second port power path circuit configured to control a second current supplied to a second port output. The second port power path circuit is further configured to provide a second overload signal to a second overload output and remain in an overload state for a second time interval responsive detecting the second current exceeds a respective current limit setting. The second port power path circuit is configured to enter a current limit state responsive to the first overload signal.

In yet another described example, a system includes a power supply having a power supply output. The power supply is configured to supply power to the power supply output. A first port power circuit has a first power input, a first power output, a first interlock input and a first overload output. The first power input is coupled to the power supply output. A second port power circuit has a second power input, a second power output, a second interlock input and a second overload output. The second power input is coupled to a power supply output, and the first interlock input coupled to the second overload output.

### BRIEF DESCRIPTION OF THE DRAWINGS

FIG. 1 shows an example of multiple power circuits configured to provide power to respective output ports.

FIG. 2 shows an example of power path control circuitry for a multi-port charging system.

FIG. 3 is a graph showing voltage and current signals for the circuit of FIG. 2 responsive to detecting an overload condition.

FIG. 4 is an example of a port power circuit.

FIG. 5 is a state diagram showing example state transitions for a multi-port charging system.

FIG. 6 is a circuit diagram showing part of a multi-port charging system.

### DETAILED DESCRIPTION

Example embodiments relate to circuitry and systems configured to control power applied to respective ports of a multi-port charging system. As one example, the circuitry is implemented as a universal serial bus (USB) charging circuit having multiple ports adapted to supply power (e.g., voltage and current) to one or more electronic devices, such as smartphones, gaming devices, notebook computers, tablet computers and the like, connected respectively to each port. In a further example, the USB charging circuit includes multiple USB 3.0 (e.g., type-C) ports, which can also be referred to as connectors, pins or terminals. The charging circuitry thus can be implemented as a USB charging circuit of an interface to a respective device, such as a vehicle (e.g., automobile, boat, motorcycle or the like), a computer or other electronic device configured to support charge and data capabilities for the device.

As a further example, the circuitry includes first and second port power circuits in which an interlock input of the first port power circuit is coupled to an overload output of the second port power circuit. Also, an interlock input of the second port power circuit is coupled to an overload output of the first port power circuit. The first and second port power circuits include respective port overload detection circuitry configured to provide an overload signal at the overload output thereof responsive to detecting a current overload. Responsive to receiving the overload signal at the interlock input, the respective port power circuit is configured to limit current that is supplied to a respective port.

In an example, the overload detection circuitry is configured to implement a two level current limit scheme, which is used to determine the overload condition when the sensed current for the respective port is above a first current limit setting (e.g., also referred to as a primary or low current limit setting or low current threshold) and below a second, higher current limit setting (e.g., also referred to as a secondary or high current limit setting or high current threshold). The first and second current limit settings for the respective port circuits can be the same or they can be different. The port detecting the overload condition can support an overload for a time interval and provide current up to the second current limit setting. For example, the time interval during which the overload is allowed can be set by deglitch circuitry responsive to the overload signal. During the time interval when an overload condition is supported at one port, the other port (or other ports, if more than two ports) are disabled from supporting an overload. After supporting the overload for the time interval, the respective port is configured to return to its first (e.g., lower) current limit setting. When the port, which detected the overload, returns to its first current limit, the overload signal changes states so the other port (or ports) is released from the overload and allowed to support an overload (e.g., up to its second current limit setting).

By allowing port circuitry that detects an overload to remain in an overload condition for a duration while limiting current of other ports of the system, a multi-port overload condition can be prevented. For example, if overloads were to occur simultaneously at multiple ports, then all output ports can brown out, which is undesirable. Thus, the circuits and systems described herein can prevent such brown outs by implementing an interlocking control technique between port circuits. As used herein, the term interlocking and variants of this term refer to a technique to prevent the both ports from supporting overload conditions simultaneously.

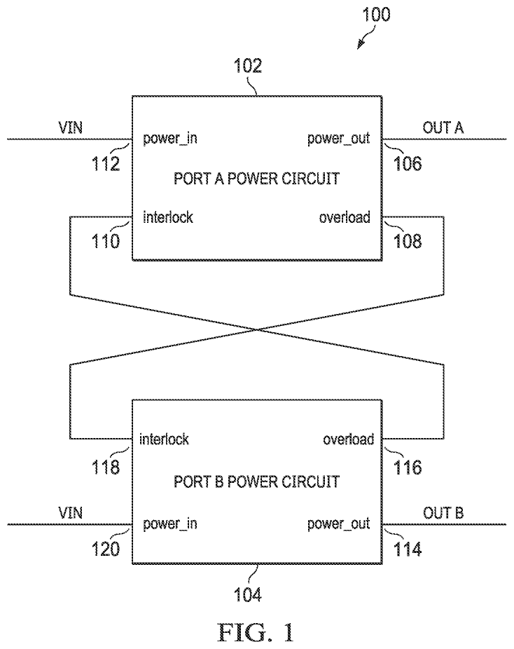

FIG. 1 shows a charging system 100 configured to control power that is supplied to multiple ports, such as port A and port B. The system 100 includes multiple port power circuits 102 and 104. While two such port power circuits 102 and 104 are shown in FIG. 1 for respective ports A and B, there can be any number of such port power circuits in a multi-port charging system 100 depending on the number of ports. In an example, each port power circuit is implemented in an integrated circuit (IC) chip or both port power circuits can be implemented in a common IC or as part of a system on chip (SoC).

The port power circuit 102 has a first power output 106, a first overload output 108, a first interlock input 110 and a power input 112. Similarly, the second port power circuit 104 has a second power output 114, a second overload output 116, a second interlock input 118 and a power input 120. As shown, the overload output 108 of the port A power circuit 102 is coupled to the interlock input 118, and the overload output 116 of the port B power circuit 104 is coupled to the interlock input 110.

The power input 112 is adapted to be coupled to a power supply. The power supply is configured to provide an input supply voltage (VIN) to the respective power circuits 102 and 104. The port A power circuit 102 is configured to provide an output voltage signal VOUT_A at the power output 106. The port B power circuit 104 likewise is configured to provide an output voltage signal VOUT_B at the power output 114. In an example, each of the port power circuits is a respective charging circuit, and the power outputs 106 and 114 are coupled to respective terminals of a USB port (e.g., a USB type-C port).

Each of the port A and port B power circuits 102, 104 can be configured to operate in one of a plurality of operating states. For example, at power up and/or in the absence of output current exceeding one or more current thresholds, the port circuits 102 and 104 operate in a normal operating state. As used herein, the normal operating state refers a mode of operation, in which the port A or port B power circuits 102, 104 uses its high current limit setting to enable output current up to the high current limit setting. The one or more current thresholds can match respective current limit settings implemented by the respective port circuits 102 and 104. As described herein, each of the port A and port B power circuits 102, 104 can also operate in a current limit state, in which the respective port A or port B power circuit is configured to limit current supplied to its respective output.

The port power circuit 102 is also configured to detect an overload condition for port A responsive to the current sensor signal. For example, the port power circuit 102 includes overload detection circuitry configured to detect an overload condition when the current sensor signal is above a current threshold. In an example, the port power circuit 102 has a low current threshold and high current threshold, and the overload condition exists when the sensed current is between the low and high thresholds. For example, the low current threshold is set to a low current limit setting and the high current threshold is set to a high current limit setting for the port A power circuit 102. When the sensed current exceeds the high current threshold, the port A power circuit 102 can trigger a fault condition for port A, such as described herein.

The port power circuit 102 is configured to provide an overload signal at 108 responsive to detecting the overload condition, which is provided to the interlock input of the port B power circuit 104. The port B power circuit 104 is configured to limit current provided to the port B power transistor responsive to the overload signal provided at 108 and received at 118. In an example, the port B power circuit 104 is configured to disable its high current limit responsive to the overload signal received at interlock input 118 indicating an overload event at port A. Because the current is limited by the port B power circuit 104 (e.g., to a current level at or below a low current limit setting so no overload event can be supported at port B), the port A power circuit 102 can support the overload event and provide a current above the current limit setting (e.g., up to a higher current limit setting) for a time interval. For example, the time interval can be set to a time period designed to enable the overload at port A while also permitting current up to a low current limit setting at port B without overloading the input power supply (e.g., a DC/DC converter) that supplies the input voltage VIN to the system 100.

For example, the port A power circuit 102 includes interlock logic configured to set a time interval during which the overload is allowed to be supported at the port A power circuit 102 responsive to detecting the overload. After supporting the overload for the time interval, the port A power circuit 102 is configured to return to a low current limit state in which the port A power circuit 102 is configured to limit output current to a low current limit setting. Also, when returning to the low current limit state after implementing the overload for the time interval, the port A power circuit 102 is also configured to change the state of the overload signal at 108 to a value representative of no longer being in the overload state (e.g., now in the low current limit state). The port B power circuit 104 is configured to allow support of an overload (e.g., up to the high current limit setting) responsive to the overload signal received at interlock input 118 having a value representative of port A power circuit 102 no longer having an overload event.

As a further example, the port B power circuit 104 is implemented as another instance of the same circuitry as used to implement the port A power circuit 102. Thus, the port B power circuit 104 includes an overload detector configured to determine an overload event responsive to a current signal that is representative of the output power at output 114. For example, port B power circuit 104 includes a current sensor that provides a sensor signal representative of current supplied by a power transistor to the output port 114. During a normal operating state (e.g., no overload signal at interlock input 118), the port B power circuit 104 is configured to support an overload event. For example, responsive to detecting an overload event, the port B power circuit 104 is configured enter a current limit state. In particular, the port B power circuit 104 includes interlock logic configured to operate the port B circuit in the high current limit state for a time interval. In the high current limit state, the port B power circuit 104 is configured to provide an output current to the power output 114 above a low current limit setting, such as up to a high current limit setting when multiple current limit settings are implemented. The port B power circuit 104 is further configured to provide an overload signal at overload output 116 during the overload event responsive to detecting the overload from the current signal at 120. The overload signal is supplied to the interlock input 110 of the port A power circuit 102. The port A power circuit 102 is configured to limit current supplied to power output 106 (e.g., according to a low current limit setting) responsive to the overload signal at 110 provided by port B power circuit 104. Because the port A power circuit 102 limits current in this way (responsive to the overload signal at 110), the port A power circuit 102 (as well as any other ports implemented in the system 100) cannot sustain an overload during the overload event at the port B power circuit 104. As a result, the input power supply, which supplies the input voltage VIN to the port power circuits 102 and 104, can supply sufficient current to the respective port power circuits without going into a current limit state and without causing a brown out on all the ports.

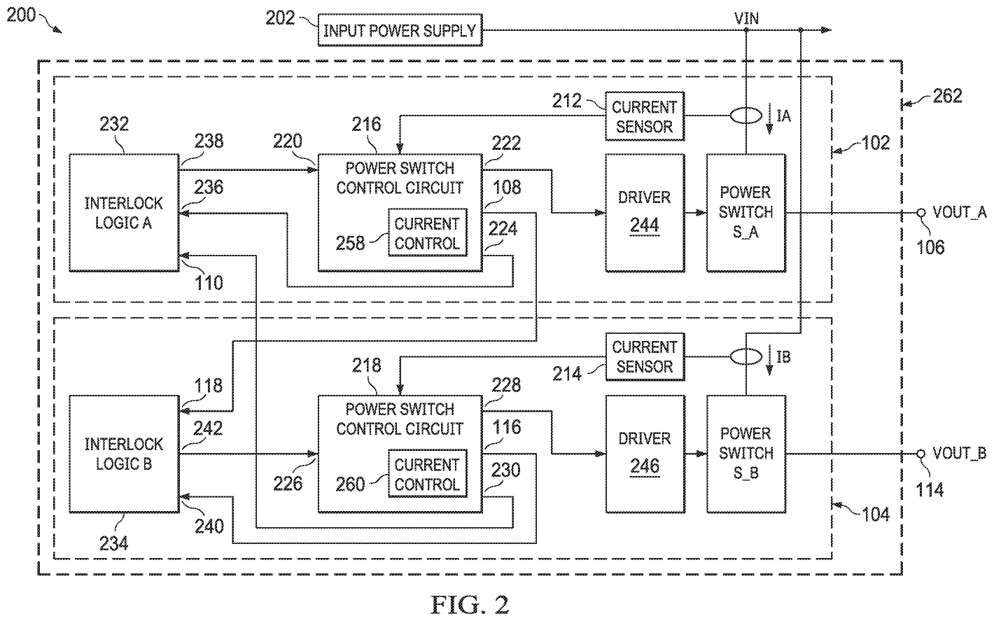

FIG. 2 illustrates an example of a charging system 200. The charging system 200 includes the port A power circuit 102 and the port B power circuit 104 from FIG. 1. Accordingly, the description of FIG. 2 also refers to FIG. 1. The system 200 includes power switches (e.g., power transistors) S_A and S_B coupled between an output of an input power supply 202 and a respective port output 106, 114. In an example, each of port outputs 106 and 114 is adapted to be coupled to one or more VBUS pins of a respective USB port, such as a USB type-C port of a multi-port system. The input power supply 202 can be implemented as a DC/DC converter configured to supply a DC input voltage (VIN) and current to the charging system 200.

As an example, the power switches S_A and S_B can be implemented as metal oxide semiconductor field effect transistors (MOSFETs). In other examples, the power switches S_A and S_B can be implemented as other types of transistors, such as insulated-gate bipolar transistors (IGBTs), bipolar junction transistors (BJTs), laterally-diffused metal-oxide semiconductor (LDMOS) transistors, and the like.

The system 200 also includes a current sensor 212 coupled between the input power supply 202 and the power switch S_A. Another current sensor 214 is coupled between the input power supply 202 and the power switch S_B. The current sensor 212 has an output coupled to a sense input of a power switch control circuit 216 for port A. The current sensor 214 also has an output coupled to a sense input of another power switch control circuit 218 for port B. In another example, the respective current sensors 212 and 214 could be coupled anywhere along a path between the power supply output and the respective port outputs 106 and 114. The current sensor 212 is configured to provide a current sensor signal to the sense input of the control circuit 216 representative of electrical current provided to the output 106 through the power switch S_A. Similarly, current sensor 212 is configured to provide a current sensor signal to the sense input of the control circuit 218 representative of electrical current provided to the output 114 through the power switch S_B.

The power switch control circuit 216 has a current limit set input 220, an overload output 108, a control output 222 and a current state output 224. Similarly, the power switch control circuit 218 has a current limit set input 226, an overload output 116, a control output 228 and a current state output 230. The current state outputs 224, 230 can include a number of outputs for providing signals representative of current conditions of the respective port (e.g., current limits, overload, fault condition etc.). Each of the port power circuits 102, 104 also includes an interlock logic circuit 232, 234.

The interlock logic circuit 232 has an interlock input 110, a current state input 236 and a current set output 238. The interlock input 110 for port A is coupled to the overload output 116 of port B. The current state input 236 is coupled to the current state output 224 and the current limit set input 220 is coupled to the current set output 238. The interlock logic circuit 234 has an interlock input 118, a current state input 240 and a current set output 242. The interlock input 118 for port B is coupled to the overload output 108 of port A. The current state output 240 is coupled to current state input 230, and the current set output 242 is coupled to current set input 226. As described herein, the cross-coupling of interlock inputs and overload outputs enables the charging system 200 to support an overload at one port power output 106 or 114 for a time interval without causing the input power supply 202 to limit current during the time interval.

The control output 222 of control circuit 216 is coupled to an input of driver circuit 244, and the control output 228 of control circuit 218 is coupled to an input of driver circuit 246. For example, the control circuit 216 can provide one or more control signals (e.g., digital control signals) to control the driver 244. The driver circuits 244, 246 each have a driver output coupled to a control input of a respective power switch S_A, S_B. For example, the power switch control circuit 216 is configured to provide an analog control signal to the driver circuit 244 responsive to the current sensor signal provided by the current sensor 212. The power switch control circuit 218 also can be configured to provide a control signal to the driver circuit 246 responsive to the current sensor signal provided by the current sensor 214. In other examples, the power switch control circuits 216, 218 can provide respective drive control signals responsive to one or more other signals representative of respective operating conditions (e.g., input voltage VIN, temperature, fault conditions etc.) determined (e.g., by control circuit 216, 218) for the respective port. The driver circuits 208 and 210 are configured to provide driver signals to respective control inputs of switches S_A and S_B responsive to drive control signals from respective control circuits 216 and 218. The power switches S_A and S_B thus are configured to supply power (voltage and current) to respective port outputs 204 and 206 responsive to the driver signals.

In the example of FIG. 2, each of power switch control circuits 216, 218 includes a respective current control circuit 258, 260. The current control circuit 258 is configured to limit current provided to the port output 106 responsive to the sensed current (from current sensor 212) and one or more current limit settings. For example, the current control circuit 258 includes one or more current limit settings, which can be used to configure one or more respective current thresholds. As a further example, a current reference (representative of a current threshold value) is created and put through a reference switch (e.g., transistor), which is configured to match the power switch S_A to create a voltage reference. The voltage reference provides an input to a comparator. Another input of the comparator senses the voltage across the power switch. The current control circuit 258 is configured to set the current limit setting to a value representative of the current reference times the ratio of the power switch S_A to the reference switch. The current control circuit 258 can also be configured to detect an overcurrent (e.g., overload) condition responsive to the sensed current exceeding a first current limit threshold (e.g., representative of the first current limit setting (CL_1)) but less than the second current threshold (e.g., representative of the second current limit setting (CL_2)). Also, depending on an operating state of the port A power circuit 102 or responsive to an overload at port B, the current control circuit 258 can use the first or second current limit setting to configure the port A power circuit 102 to limit the magnitude of current supplied to the output 106.

Similarly, the current control circuit 260 is configured to limit current provided to the port output 114 responsive to the sensed current (from current sensor 214) and one or more current limit settings. For example, the current control circuit 260 includes one or more configurable current limit settings. The current control circuit 260 can also be configured to detect an overcurrent (e.g., overload) condition responsive to the sensed current at port B exceeding a first current threshold but less than the second current threshold. Also, the current control circuit 260 can configure the port A power circuit 102 to limit the magnitude of current supplied to the output 114, such as based on an operating state of the port B power circuit 104 or responsive to an overload at port A.

As shown in the example of FIG. 2, the output 108 of port A control circuit 216 is coupled to the interlock input 118 of the interlock logic 234. Similarly, the output 116 of port B control circuit 218 is coupled to the interlock input 110 of the interlock logic 232. In an example, both port power circuits 102 and 104 are initially in a normal operating state enabled to use the second current limit setting (e.g., set by second current control circuits 258, 260) to allow current up to the second current limit setting at respective port outputs 106 and 114. For example, the second current limit setting (CL_2) for each port power circuit 102, 104 is functionally related to a first current limit setting (CL_1) of the respective power circuit (e.g., CL_2=1.6×CL_1). In an example, the low current limit setting CL_1=3.5 A and the high current limit setting CL_2=5.6 A. Other current limit settings can also be used. Responsive to one of current control circuits 258, 260 detecting that the sensed port current IA or IB exceeds a respective current threshold, e.g. the first current limit setting (CL_1), the control circuit 216 or 218 detecting the overcurrent is configured to provide an overload signal representative of the detected overcurrent event.

For example, the detecting control circuit 216, 218 is configured to provide the overload signal (e.g., a logic high) to the interlock input 118, 110 of the interlock logic 234, 232 of the other port power circuit. The interlock logic 232, 234 is configured to provide a set current limit command at current set output 238, 242 responsive to receiving the overload signal from the other port. The current control circuit 258, 260 is configured to enter a low current limit state and use a low current limit setting (CL_1) and disable use of any higher current limit setting (e.g., CL_2) responsive to the set current limit command received at current limit set input 220, 226. After supporting the overload for a time interval (e.g., approximately 1-2 ms), the current control circuit 258, 260 detecting the overcurrent is then configured to disable its second current limit setting (e.g., CL_2) and use the first current limit setting (CL_1) to control current provided to the respective output 106, 114. In an example, the time interval is programmable and may vary depending on the current limit setting. Also, after the time interval, the current control circuit 258, 260 detecting the overcurrent can be configured to change the state of the overload signal provided at 108, 116 (e.g., to logic low), which re-enables the current control 260, 258 of the other port power circuit to use the second, higher current limit setting (CL_2) so such other port power circuit can again support an overload condition up to the second current limit setting.

In another example, the port A power circuit 102, the port B power circuit 104 and respective driver circuits 208 and 210 collectively form power path circuitry 262. The power path circuitry 262 thus is configured to control power supplied to respective ports (e.g., two or more USB ports), including implementation of current limiting and fault protecting techniques. The power path circuitry 262 can be integrated in an IC chip, in which the interlocking overload signals are coupled between respective instances of the port power circuits.

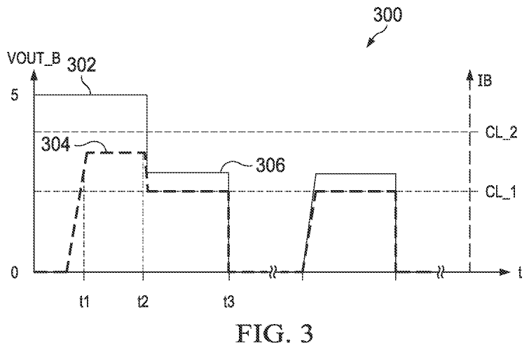

FIG. 3 is a graph 300 showing voltage and current signals for the charging system 200 of FIG. 2. The voltage VOUT_B is representative of the voltage provided at the output 114 for port B, and is shown at 302 by solid lines. The current IB is representative of current supplied to output 114 through power switch S_B, and is shown at 304 by dashed lines. In the example of FIG. 3, the output voltage VOUT_B, shown at 302, is initially at 5V and no current is provided (e.g., switch S_B is on bit the switch current is 0 A). Current IB increases to a magnitude that is between first and second current limit settings CL_1 and CL_2, respectively. When the current IB crosses the first current limit setting CL_1 (e.g., a current threshold), an overload condition is detected as described herein. The port B power circuit 104 is configured to allow the overload condition for a time interval, as shown from time t1 to time t2. Also, as described herein, during the time interval from t1 to t2, the port B power circuit 104 provides the overload signal to interlock input (e.g., input 110) of one or more other power ports (e.g., power port A) to force such other ports to enter a current limit state. For example, in the current limit state, the current control 258 is configured to use the first current limit setting (e.g., CL_1) to prevent overload at each such other port. After the time interval, namely at time t2, the current control 260 of port B is configured to enter the first current limit state, in which the port B current control is configured to use the first (e.g., nominal) current limit setting (CL_1) setting to protect the port output 114 against overload. Also, at time t2, the port B power circuit 104 is configured to release the other ports of the multi-port system and allow them to support an overload. In an example, such as when the overload (e.g., over current) condition lasts longer than a prescribed time interval, shown at 306 (e.g., as t3-t1, such as greater than 4 ms), the switch control 218 of the port B control circuit 104 is configured to enter a hiccup mode. In the hiccup mode, the switch control 218 can implement an increased (e.g., about 500 ms of) off-time and the prescribed (e.g., about 4 ms of) on-time until the overload condition terminates. In another example, when the overload (e.g., over current) condition lasts longer than a prescribed time interval, the current control 260 is configured use the first current limit setting (CL_1) for an arbitrary time during the overload condition. While the example of FIG. 3 is described in relation to the port B power circuit 104, the port A power circuit 102 (as well as any other ports of the multi-port charging system 200) can be configured to operate in the same manner.

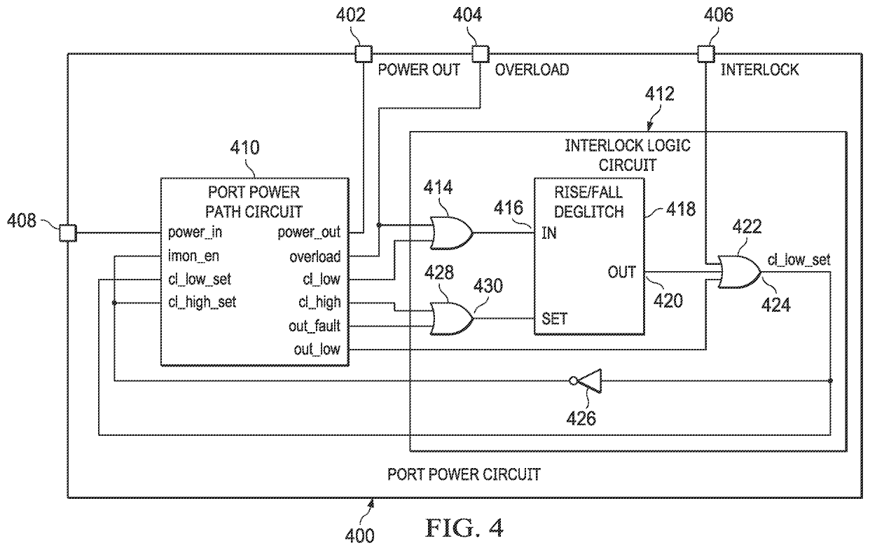

FIG. 4 illustrates an example port power circuit 400, such as can be used to implement port power circuits 102 and 104 shown in FIGS. 1 and 2. Accordingly, the description of FIG. 4 also refers to FIGS. 1 and 2. In an example, the port power circuit 400 is implemented in an IC chip or in an SoC having multiple port power circuits.

The port power circuit 400 has a power output 402, an overload output 404, an interlock input 406 and a power input 408. The output 402 (e.g., an example of output 106 or 114) provides an output voltage for the port. The power input 408 is adapted to be coupled to an output of a power supply (e.g., power supply 202), such as to receive input voltage VIN. The overload output 404 (e.g., an example of output 108 or 116) is adapted to be coupled to an interlock input of another power port circuit. The interlock input 406 (e.g., an example of input 110 or 118) is adapted to be coupled to an overload output of the other power port circuit.

The port power circuit 400 includes a port power path circuit 410 and interlock logic circuitry 412. The port power path circuit 410 has an input coupled to the power input 408 and respective outputs coupled to the power output 402 and the overload output 404. For example, the port power path circuit 410 is representative of the power switch control circuit 216 or 218, the driver circuit 244 or 246, the current sensor 212 or 214 and the power switch SW_1 or SW_2, such as shown in FIG. 2 for each port. The port power circuit 400 can also include additional circuitry (e.g., voltage references, ramp generator, comparator, dividers, logic, etc.) configured to perform various other functions. The port power circuit 400 thus is configured to provide a port output voltage and current to the to the power output 402, as described herein.

Also, the port power path circuit 410 is configured to provide an overload signal at the overload output 404 responsive to detecting an overload (e.g., when the output current provided at 402 exceeds a current limit setting). As described herein, the port power path circuit 410 is configured to detect the overload responsive to the current sensor signal (e.g., provided by current sensor 212 or 214). For example, the port power path circuit 410 includes a comparator configured to compare the current sensor signal and a reference signal representative of a low current limit setting (e.g., CL_1). The comparator can provide or trigger the overload signal with a state (e.g., a logic high or low) based on the comparison.

In the example of FIG. 4, the port power path circuit 410 also has a CL_LOW output, a CL_HIGH output, an OUT_FAULT output and an OUT_LOW output. Such outputs are representative of the output 224, 230 provided by power switch control circuit 216, 218. For example, the port power path circuit 410 is configured to provide a low current signal at the CL_LOW output when the port control circuit is in a low current limit state. In the low current limit state, the output current provided at 402 is maintained within the low current limit setting (CL_1). The port power path circuit 410 is also configured to provide a high current limit signal at the CL_HIGH output when the port control circuit is in a high current limit state. In the high current limit state, the output current provided at 402 is maintained within the high current limit setting (CL_2). In other examples, the circuit 400 can be implemented with a single current limit (e.g., CL_1). In examples where the circuit 400 is configured to implement a single current limit, the high current limit CL_2 can be implemented as threshold (e.g., a reference) used by the current control (e.g., current control 258, 260) to determine if the output current for the port exceeds the high current threshold (e.g., specified by CL_2).

The power path circuit 410 can also be configured to provide an output fault signal at the OUT_FAULT output responsive to detecting a fault condition. For example, the power path circuit 410 is configured to detect one or more fault conditions (e.g., temperature, current limit, hiccup, etc.). Also, the power path circuit 410 can be configured provide a signal at the OUT_LOW output responsive to detecting when the voltage at the output port is below an expected voltage, such as can be representative of a short circuit condition. The port power path circuit 410 output port can be configured to disable the output port 402 responsive to detecting any such fault condition.

The interlock logic circuitry 412 has inputs coupled to the respective overload output 404, the CL_LOW output, the CL_HIGH output, the OUT_FAULT output and the OUT_LOW output. The interlock logic circuitry 412 also has an input coupled to the interlock input 406. The interlock logic circuitry 412 is configured to implement an interlocking current control technique responsive to the overload signal provided (e.g., by port power path circuit 410) at 404 and/or an interlock input signal received (e.g., from another port power path circuit) at input 406. As described herein, the interlocking current control technique helps prevent more than one power port circuit from operating in an overload state simultaneously so the input power supply (e.g., power supply 202) for the multi-port system is not itself overloaded into a current limit state, which could cause a brown out on all ports of the system.

In the example of FIG. 4, the interlock logic circuitry 412 includes an OR gate 414 having inputs coupled to the overload and CL_LOW outputs of the power path circuit 410. An output of the OR gate 414 is coupled to an input 416 of a deglitch circuit 418. The OR gate 414 is configured to provide a logic high signal at the deglitch input 416 responsive to any of the overload and CL_LOW signals being in logic high states. The OR gate 414 thus drives the deglitch input 416 to a logic high responsive to the port control circuit detecting an overload (e.g., overcurrent) or responsive to port control circuit being set into a low current limit state.

The deglitch circuit 418 also has an output 420 coupled to an input of another OR gate 422. The deglitch circuit 418 is configured to delay providing a current limit set signal at a current limit set output to enable an overload state (e.g., an overcurrent) to persist at the respective port output 402 for a time interval. During such overload state, the port power path circuit 410 is configured to provide output current to the port output 402 above the current limit setting. For example, the deglitch circuit 418 is configured to delay propagation of a state change in the logic signal at 416 (e.g., changing from low to high states) and generate a delayed output signal at the output 420 responsive to the logic signal at 416. As described herein, delay is used to keep the power path circuit 410 in overload state for a time interval commensurate with the delay. The amount of delay implemented by the deglitch circuit 418 can be fixed or configurable (e.g., ranging from about 1 ms to 2 ms or more). In an example, the deglitch circuit is implemented as a state machine having a counter configured to count clock pulses responsive to the signal at 416. The counter can be configured to start the counting over responsive to the signal at 416. Alternatively, the counter can be configured to count up when the signal at 416 is present and count down when it is not present, and provide the output at 420 output if it can count up to a maximum count value. Other types of deglitch circuits can also be used.

The OR gate 422 also has inputs coupled to the interlock input 406 and the OUT_LOW output of the power path circuit 410. The OR gate 422 has an output 424 coupled to a current limit low set input (CL_LOW_SET) of the port power path circuit 410. The OR gate 422 is configured to set the power path circuit 410 into the low current limit setting responsive to any of the interlock signal at 406, the delayed output signal at 420 or the low output voltage signal at the OUT_LOW output of the power path circuit 410 being logic high. In this way, the power path circuit 410 is forced into the low current limit state substantially immediately responsive to interlock signal at input 406, which is representative of another port detecting an overload. Also, the power path circuit 410 can be forced into the low current limit state substantially immediately responsive to the low output voltage signal at the OUT_LOW output. When the high current limit is enabled (e.g., during a normal operating mode, such as power up), however, the power path circuit 410 is configured to delay transitioning from the high current limit state to the low current limit state responsive to the power path circuit 410 detecting an overload. Unless otherwise stated, in this description, “about,” “approximately” or “substantially” preceding a term means +/−5 percent (5%) of the stated result. For example, “substantially immediately” means being within +/−0.1 ms of instantaneous when a prescribed delay would be 2.0 ms.

In the example of FIG. 4, the output 424 of the OR gate 422 is also coupled to IMON_EN and CL_HIGH_SET inputs of the power path circuit 410 through an inverter 426. The inverter 426 is configured to provide an inverted version of the CL_LOW_SET signal to the IMON_EN and CL_HIGH_SET inputs of the power path circuit 410. Thus, when the CL_LOW_SET signal is logic high, representative of a command to enter the low current limit state, the power path circuit 410 is disabled from entering the high current limit state, and the current overload monitoring function of the power path circuit 410 is also disabled.

The interlock logic circuitry 412 can also include another OR gate 428 having inputs coupled to the CL_HIGH and OUT_FAULT outputs of the power path circuit 410. An output 430 of the OR gate 428 is coupled to a SET input of the deglitch circuit 418. The deglitch circuit 418 is configured to set the output 420 to a logic high, without implementing further delay, responsive to the OR gate 428 providing a logic high to the SET input of the deglitch circuit 418. The OR gate 428 can provide the logic high signal to the SET input responsive to the power path circuit 410 going into the high current limit state and/or detection of a fault condition, as described herein. When the OR gate 428 provides a logic high to the SET input, the deglitch circuit 418 asserts its output 420 substantially immediately (e.g., without imposing the delay that is applied to signals at input 416) so the port power path circuit enters into the low current limit state accordingly. Thus, the deglitch circuit 418 is configured to provide the current limit set signal at 424 to force the port power path circuit into the first current limit state responsive to the output 430 going high, and without imposing the delay that is used responsive to detecting an overload condition, as described herein.

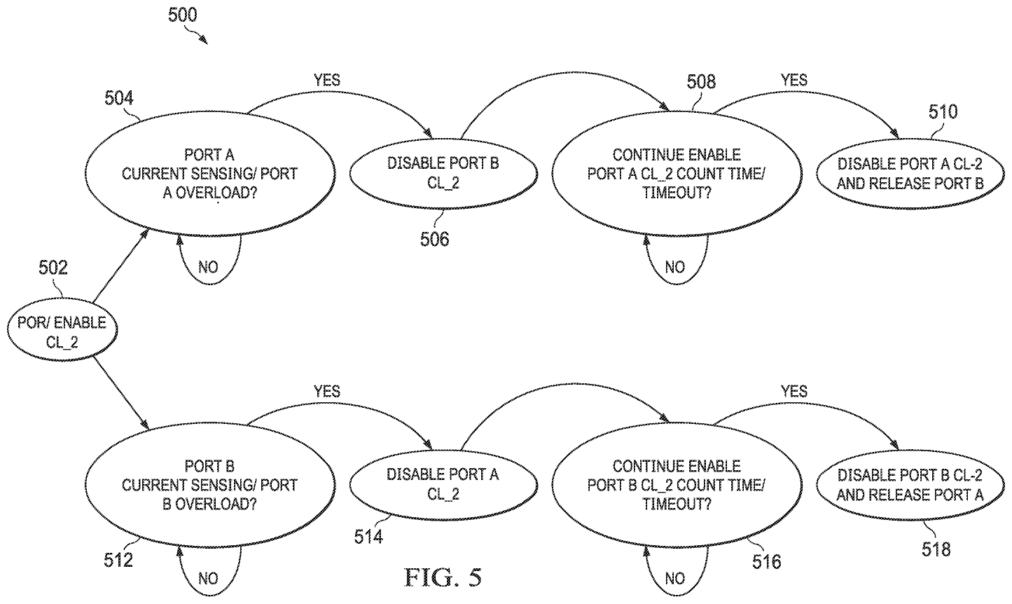

FIG. 5 is a state diagram 500 showing example state transitions for a multi-port charging system. The system includes two or more port power circuits, shown as ports A and B. Each of the port power circuits (also referred to as ports A and B) is configured to implement multiple current limit settings, such as a first current limit setting (CL_1) and a second, higher current limit setting (CL_2). At 502, in which a power-on reset (POR) occurs responsive to a power supply (e.g., power supply 202) supplying power to the respective ports. The power supply is configured to supply regulated power to the power circuits of ports A and B to initialize the respective ports A and B. For example, at POR 502, the power supply is activated to supply regulated power to each port A and B, and each port A and B is initialized. After initializing responsive to POR, each port power circuit transitions to a normal operating state 504, 512, in which a current limit setting (e.g., a high current limit setting CL_2) is used to enable respective port circuits to support an overload condition. In other examples, the port power circuits are configured to implement only a single current limit setting (e.g., CL_1), in which a high current threshold can be used to implement some controls other than current limiting. Because each port power circuit can operate independently apart from the interlocking, the interlocking operation and state transitions for respective ports A and B are described separately in FIG. 5.

At 504, during the normal operating mode, port A is configured to perform current sensing and overload detection. If no overload is detected, port A remains in state 504. Responsive to detecting an overload at port A, port A transitions to state 506 in which Port A is configured to disable use of the high current limit setting CL_2 of port B. For example, port A provides an overload signal to an interlock input of port B, which causes port B to disable CL_2 and use CL_1. Port A transitions from 506 to 508, in which port A continues to enable its high current limit CL_2 for a time interval, such as described herein. Port A remains in state 508 until the time interval has elapsed. After the time interval has elapsed, port A transitions to state 510 in which port A disables use of its high current limit setting CL_2. Also, in state 510, port A can release port B from disabling its high current limit (at 506) so port B is enabled to support an overload condition.

As mentioned, port B is configured to implement the same overload and interlocking functions with respect to port A. Thus, during the normal operating mode, at 512, port B is configured to perform current sensing and overload detection. If no overload is detected, port B remains in state 512. Responsive to detecting an overload at port B, port B transitions to state 514, in which Port B is configured to disable the high current limit setting CL_2 of port A. For example, port B provides an overload signal to an interlock input of port A, which causes port A to disable use of its high current limit setting CL_2 and use its low current limit setting CL_1. Port B transitions to 516, in which port B continues to enable its high current limit setting CL_2 for a time interval. As described herein, port B remains in state 516 until the time interval has elapsed and, after the time interval has elapsed, port B transitions to state 518. In state 518 following the time interval, port B disables its high current limit setting CL_2, and uses its low current limit setting CL_1. Also, in state 518, port B can release port A from disabling its high current limit (at 514) so port A is enabled to implement an overload condition up to its higher current limit setting CL_2.

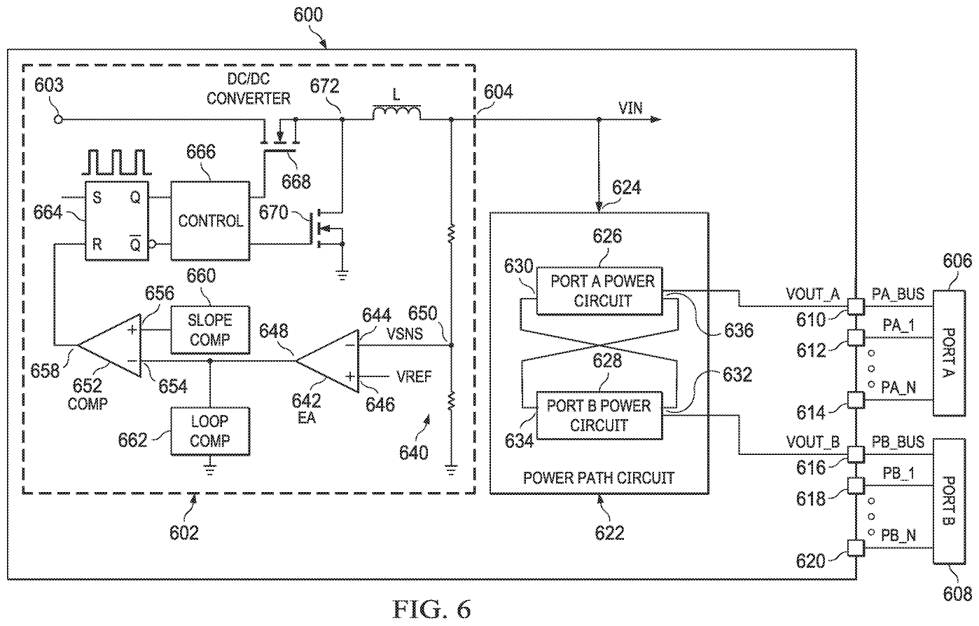

FIG. 6 is a circuit diagram showing part of a multi-port charging system 600. The system includes a DC/DC converter 602 having an input 603 and an output 604. The input 603 is adapted to be coupled to DC source, such as a battery or another power converter. The output 604 is configured to provide a DC input voltage VIN for use in supplying power to one or more ports 606, 608 of the charging system 600, shown as port A and port B. Two ports are shown in the example of FIG. 6. In other examples, more than two ports can be implemented in the multi-port charging system 600.

As shown in FIG. 6, the charging system 600 includes a set of port A terminals 610, 612 and 614 coupled to pins of port 606 and a set of port B terminals 616, 618 and 620. The number and arrangement of terminals and pins for each port 606 and 608 may be configured depending on the type of port. As an example, each of the ports 606 and 608 includes a connector having terminals (e.g., pins) configured and arranged in a pinout according to a standard or proprietary type of connector, such as USB (e.g., USB type-C) connector. Thus, each port 606, 608 is adapted to be coupled to a respective mating connector, such as a plug at an end of cable or other device.

For example, terminal 610 of port A is configured as a power terminal configured to supply power (e.g., voltage and current) from the charging system 600 to a respective power terminal of port A over a connection shown as PA_BUS. Similarly, terminal 616 is configured as another power terminal configured to supply power (e.g., voltage and current) from the charging system 600 to a respective power terminal of port B over a connection shown as PB_BUS. The other terminals 612-614 and 618-620 for the respective ports 606 and 608 can be adapted to provide power, data or other information over connections, shown as PA_1 through PA_N for port A and PB_1 through PB_N for port B (where N is a positive integer representative of the number of respective port connections).

The system 600 includes a power path circuit 622 having an input 624 coupled to the output 604 of the converter 602. The power path circuit 622 includes a port A power circuit 626 and a port B power circuit 628. Each of the port A and B power circuits 626 and 628 may be implemented as a respective instance of the port power circuit 102, 104 or 400, as described herein. As such, each of the port A and B power circuits 626 and 628 can include circuitry (e.g., an instance of port power path circuit 410 and interlock logic circuitry 412) configured to implement the functions shown and described with respect to the state diagram 500 of FIG. 5.

For example, the port A power circuit 626 has an interlock input 630 coupled to an overload output 632 of the port B power circuit 628. Also, the port B power circuit 628 has an interlock input 634 coupled to an overload output 636 of the port A power circuit 626. The port power circuits 626 and 628 include respective port overload detection circuitry configured to provide an overload signal at the overload output 636, 632 thereof responsive to detecting a current overload for the respective port 606, 608. Each port power circuit 626 or 628 is configured to limit current supplied to its respective port 606 or 628 (e.g., to its low current limit setting) for a time interval responsive to detecting a current overload. In an example, the overload detection circuitry is configured to implement a multi-level current limit scheme, which is used to determine and support the overload condition. For example, an overload condition exists at a respective port 606, 608 when the sensed current for the respective port is above a low current limit setting and below a second, higher current limit setting. Alternatively, each port can implement a single current limit setting. Also, each port power circuit 626 or 628 is disabled from supporting an overload and is configured to limit current that is supplied to its respective port 606 or 628 (e.g., up to its low current limit setting) responsive to receiving the overload signal at its respective interlock input 630, 634. After supporting the overload for the time interval, the respective port, which detected the overload, is configured to change states from its second current limit state to its first (e.g., lower) current limit state. When the port, which detected the overload, returns to its first current limit state, the overload signal also changes states so the other port (or ports) is released from the interlocking overload and thus allowed to support an overload (e.g., up to its second current limit setting).

By allowing the port circuitry that detects an overload to remain in an overload condition for a duration while disabling other port power circuits from supporting an overload simultaneously, a multi-port overload condition can be prevented. For example, if overloads were to occur simultaneously at multiple ports, then all output ports could brown out due to overloading the converter 602. The approach described herein prevents such potential brown out because if one port is in overload, the other port's (or ports') output capability is substantially immediately limited through the interlocking current control.

In the example of FIG. 6, the DC/DC converter 602 is shown as a buck converter coupled between the input 603 and output 604. The converter 602 includes a voltage sensor 640, shown as a divider circuit (e.g., a resistive divider having resistors R1 and R2) coupled between the output 604 and ground. An error amplifier 642 has inputs 644 and 646 and an output 648. The input 644 is coupled to a junction 650 between R1 and R2 to provide a sensed voltage VSNS representative of an output voltage at the output 604. As described above, the output voltage at 604 is also supplied as the input voltage VIN to the port charging system. The input 646 is configured to receive a DC reference voltage VREF (e.g., 5 V). The error amplifier 642 is configured to provide and error signal at the output 648 representative of a difference between VSNS and VREF.

A comparator 652 has inputs 654 and 656 and an output 658. The output 648 of the error amplifier is coupled to the comparator input 654. The comparator input 656 is configured to receive a slope compensation signal from slope compensation circuitry 660, such as to help stabilize the converter 602. A loop compensation circuit 662 can also be coupled to the output 648. The loop compensation circuit 662 can be configured to help stabilize the closed loop transfer function of the converter 602 by adjusting the error signal provided to the comparator input 654. The comparator output 658 is coupled to a reset input of a latch circuit 664, shown as an S-R flip flop. The comparator 652 thus is configured to provide a comparator output signal to the reset input of the latch circuit 664. The latch circuit 664 has outputs (Q and Q) coupled to inputs of a control circuit 666. The control circuit 666 has outputs coupled to respective power devices 668 and 670. For example, the power devices 668 and 670 are implemented as MOSFETs, IGBTs, BJTs, LDMOS transistors, or the like. In the example shown in FIG. 6, each of the power devices 668 and 670 is a FET having a respective gate coupled to a respective output of the control circuit 666. The power device 668 is coupled in series with an inductor L between the input 603 and the output 604. A capacitor (not shown) can also be coupled at the output 604 (e.g., between the output and ground). The power device 670 is coupled between a terminal 672 of the inductor and ground, as shown. The control circuit 666 thus is configured to operate the FETs 668 and 670 in a push-pull manner responsive to the outputs from the latch circuit 664, in which control circuit provides control signals (e.g., pulses) to activate the power device 668 to supply current to charge the inductor L in a first phase while the other power device 670 is off. Then, in a next phase, the control circuit 666 is configured to turn off the power device 668 and to activate power device 670 to pull current from the inductor L responsive to the outputs from the latch circuit 664. The control circuit 666 can repeat the process each clock cycle to regulate the voltage and current supplied to the charging system.

As a further example, the second current limit setting is determined as a function of the first current limit setting (e.g., CL_2=1.6×CL_1). If the two ports 606 and 608 pull out large current at the same time, then the DC/DC converter 602 is overloaded, and DC-DC converter output voltage can crash and insufficient current be available to support he overload. To avoid these potential issues, the power path control circuitry is configured to implement an interlocking scheme, as described herein, to manage the current limit settings of the ports 606 and 608. As a result, if one port's current exceeds the low current limit threshold, then the current limit thresholds of the other port will be overridden to the low current limit setting immediately. With this interlocking control scheme, the system 600 only allows one port to output a large current, such as high as 1.6× of the first current limit setting at the same time. This also helps ensure the DC/DC converter 602 has enough energy to sustain its output voltage.

In this description, the term “couple” or “couples” means either an indirect or direct connection. Thus, if a first device couples to a second device, that connection may be through a direct connection or through an indirect connection via other devices and connections. For example, if device A generates a signal to control device B to perform an action, in a first example device A is coupled to device B, or in a second example device A is coupled to device B through intervening component C if intervening component C does not substantially alter the functional relationship between device A and device B such that device B is controlled by device A via the control signal generated by device A.

The recitation “based on” means “based at least in part on.” Therefore, if X is based on Y, X may be a function of Y and any number of other factors. Similarly, the recitation “responsive to” means “responsive at least in part to.” Therefore, if X is responsive to Y, X may be a function of Y and any number of other factors.

Modifications are possible in the described embodiments, and other embodiments are possible, within the scope of the claims.

What is claimed is:

1. A circuit comprising:
a port power path circuit having a power input and a first overload output; and
an interlock logic circuit having an interlock input, a current limit input and a current limit set output, the current limit input coupled to the first overload output, the interlock input adapted to be coupled to a second overload output of a second port power circuit, the interlock logic circuit configured to delay providing an output signal to the current limit set output responsive to an overload signal at the current limit input.

2. The circuit of claim 1, wherein
the port power path circuit has a current limit output, and
the interlock logic circuit comprises OR-logic having first and second logic inputs and an output, the first logic input coupled to the current limit output and the second logic input coupled to the first overload output, the output of the OR logic coupled to the current limit input.

3. The circuit of claim 2, wherein the interlock logic circuit comprises a deglitch circuit having the current limit input and a deglitch output, the deglitch output coupled to the current limit set output.

4. The circuit of claim 3, wherein the deglitch circuit is configured to delay the overload signal for a time interval and provide a delayed version of the overload signal at the deglitch output, the port power path circuit configured to enable current to be provided to a port output above a current limit setting and for the time interval responsive to the delayed version of the overload signal.

5. The circuit of claim 4, wherein the interlock logic circuit comprises second OR-logic having first and second logic inputs and the current limit set output, the first logic input of the second OR-logic coupled to the interlock input, the second logic input of the second OR-logic coupled to the output of the deglitch circuit.

6. The circuit of claim 5, wherein the second OR-logic is configured to provide a current limit set signal at the current limit set output responsive to any of (1) an overload signal from the second port power circuit received at the interlock input, or (2) the delayed version of the overload signal.

7. The circuit of claim 5, wherein the interlock logic circuit comprises third OR-logic having first and second logic inputs and a set output, the first logic input of the third OR-logic coupled to a high current limit output of the port power path circuit, the second logic input of the third OR-logic coupled to a fault output of the port power path circuit, the set output coupled to a set input of the deglitch circuit.

8. The circuit of claim 1, further comprising a current sensor having a current sensor output.

9. The circuit of claim 8, wherein the port power path circuit comprises:
a power switch control circuit having a sensor input and a control output, in which the sensor input is coupled to the current sensor output;
a driver circuit having a driver input and a driver output, the driver input coupled to the control output; and
a power switch having a control input, a power input and a power output, the control input coupled to the driver output, the power input adapted to be coupled to a power supply, and the power output coupled to the port output.

10. The circuit of claim 9, wherein
the current sensor is configured to provide a current sensor signal at the sensor output representative of current provided to the port output, and
the power switch control circuit comprises current control circuit configured to detect an overcurrent condition and provide the overload signal at the first overload output responsive to the current sensor signal.

11. The circuit of claim 10, wherein the current control circuit is configured to detect the overcurrent condition responsive to detecting the current provided to the port output exceeds a first current limit setting and less than a second current limit setting, the second current limit setting being greater than the first current limit setting.

12. The circuit of claim 9, wherein the port output is coupled to a power terminal of a universal serial bus connector.

13. The circuit of claim 1, wherein the port power path circuit is a first port power path circuit and the interlock logic circuit is a first interlock logic circuit, the first port power path circuit and the first interlock logic circuit are part of a first port power circuit, the circuit further comprising:
the second port power circuit, comprising:
a second port power path circuit having a respective current limit set input and the second overload output, the second overload output coupled to the interlock input of the first interlock logic circuit; and
a second interlock logic circuit having a second interlock input, a second current limit input and a second current limit set output, the second current limit input coupled to the second overload output, the second interlock input coupled to the first overload output, and the second current limit set output coupled to the respective current limit set input of the second port power path circuit.

14. A circuit comprising:
a first port power circuit including a first port power path circuit configured to control a first current supplied to a first port output, the first port power path circuit further configured to provide a first overload signal to a first overload output and remain in an overload state for a first time interval responsive to detecting the first current exceeds a respective current limit setting; and
a second port power circuit including a second port power path circuit configured to control a second current supplied to a second port output, the second port power path circuit further configured to provide a second overload signal to a second overload output and remain in an overload state for a second time interval responsive detecting the second current exceeds a respective current limit setting, the second port power path circuit configured to enter a current limit state responsive to the first overload signal.

15. The circuit of claim 14, wherein the first port power circuit comprises:
a deglitch circuit configured to provide a delayed version of the first overload signal at a deglitch output so the first port power circuit operates in the overload state for the first time interval, during which the first port power circuit is configured to enable the first current to be supplied to the first port output above the respective current limit setting of the first port power circuit.

16. The circuit of claim 14, wherein the respective current limit setting of the first port power circuit is a first current limit setting, the circuit further comprising:
a current sensor configured to provide a current sensor signal representative of the first current supplied to the first port output,
wherein the first port power circuit comprises a current control circuit configured to detect an overcurrent condition responsive to the first current exceeding the first current limit setting, the first port power path circuit configured to provide the first overload signal to the first overload output responsive to the current control circuit detecting the overcurrent condition.

17. The circuit of claim 16, wherein the current control circuit is configured to detect the overcurrent condition when the first current exceeds the first current limit setting and is less than a second current limit setting, in which the second current limit setting is greater than the first current limit setting, the first port power path circuit further configured to allow the first current to flow up to the second current limit setting for the first time interval.

18. The circuit of claim 17,
wherein the first port power circuit comprises an interlock logic circuit configured to delay the first overload signal for the first time interval, the first port power path circuit configured to enable the first current to be provided above the current limit setting and up to the second current limit setting for the first time interval responsive to the delay of the first overload signal.

19. The circuit of claim 18, wherein
the interlock logic circuit further comprises OR-logic configured to provide a current limit set signal responsive to any of (1) an overload signal from the second port power circuit received at an interlock input or (2) a delayed version of the overload signal, and
the first port power path circuit is configured to enable the first current to be provided above the first current limit setting up to the second current limit setting responsive to the current limit set signal.

20. The circuit of claim 19, wherein
the current limit state is a first current limit state,
the interlock logic circuit further comprises a set input configured to receive an input logic signal representative of the first port power circuit operating in a second current limit state, the interlock logic circuit configured to provide the current limit set signal to force the first port power circuit into the first current limit state responsive to the input logic signal and without imposing the delay.

21. The circuit of claim 14, wherein
the first port power path circuit comprises:
a first current sensor configured to provide a first current sensor signal representative of current supplied to the first port output; and
a first power switch control circuit configured to provide a first control signal responsive to the first current sensor signal; and
the second port power path circuit comprises:
a second current sensor configured to provide a second current sensor signal representative of current supplied to the second port output; and
a second power switch control circuit configured to provide a second control signal responsive to the second current sensor signal.

22. The circuit of claim 21, further comprising:
a power supply having a power supply output, the power supply configured to supply regulated power to the power supply output;
a first power switch coupled between the power supply output and the first port output;
a second power switch coupled between the power supply output and the second port output;
a first driver circuit configured to control the first power switch to supply the first current responsive to the first control signal; and
a second driver circuit configured to control the second power switch to supply the second current responsive to the second control signal.

23. The circuit of claim 14, wherein each of the first and second port outputs is coupled to a respective power terminal of a respective universal serial bus connector.

24. A system comprising:
a power supply having a power supply output, the power supply configured to supply regulated power to the power supply output;
a first port power circuit having a first power input, a first port output, a first interlock input and a first overload output, the first power input coupled to the power supply output; and
a second port power circuit having a second power input, a second port output, a second interlock input and a second overload output, the second power input coupled to the power supply output, and the first interlock input coupled to the second overload output.

25. The system of claim 24, further comprising:
a first universal serial bus connector having a first power terminal coupled to the first port output; and
a second universal serial bus connector having a second power terminal coupled to the second port output.

26. The system of claim 24, wherein the first port power circuit comprises:
a port power path circuit having the first power input, a current limit set input and the first overload output; and
an interlock logic circuit having the first interlock input, a current limit input and a current limit set output, the current limit input coupled to the first overload output, and the current limit set output coupled to the current limit set input.

27. The system of claim 24, wherein
the first port power circuit is configured to provide an overload signal to the first overload output and remain in an overload state for a time interval responsive to detecting a current supplied to the first port output exceeds a current threshold, and
the second port power circuit is configured to limit the current supplied to the second port output responsive to the overload signal.
